(19) United States
(12) Patent Application Publication
(10) Pub. No.: US 2017/0142519 A1
(43) Pub. Date: May 18, 2017

(54) DIGITAL MICROPHONES

(71) Applicant: Cirrus Logic International Semiconductor Ltd., Edinburgh (GB)

(72) Inventor: Jean Pierre Lasseuguette, Edinburgh (GB)

(73) Assignee: Cirrus Logic International Semiconductor Ltd., Edinburgh (GB)

(21) Appl. No.: 14/943,425

(22) Filed: Nov. 17, 2015

(51) Int. Cl. H04R 3/06; H04R 19/04; G10L 19/22

(52) U.S. Cl. CPC H04R 3/06; G10L 19/22; H04R 19/04; H04R 2201/003

(57) ABSTRACT

This application relates to methods and apparatus for relates to methods and apparatus for operating digital microphones, and in particular to biasing of digital microphones. The application discloses a circuit (402) for providing a bias current (Ibias) for a digital microphone (401). A first current generator (403) is configured to receive a clock signal (CLK) supplied to the digital microphone and generate a first current based on the clock signal. The first current generator is configured to generate the first current over at least one operating band of frequencies of the clock signal such that the first current varies with the frequency of the clock signal over substantially the whole of said operating band of frequencies. The bias current is based on said first current and in some embodiments the first current may be provided as the bias current.

### FIELD OF THE DISCLOSURE

This application relates to methods and apparatus for operating digital microphones, and in particular to biasing of digital microphones and especially to digital microphones operable at different clock frequencies.

### BACKGROUND

Digital microphones are known and are increasingly being used in some applications, such as for portable electronic devices. FIG. 1 illustrates a conventional arrangement of a digital microphone in use. The digital microphone 101 comprises a transducer such as a MEMS microphone 102 with an associated amplifier 103, e.g. a low noise amplifier, and analogue-to-digital converter (ADC) 104 co-located with the transducer 102. In some instances the amplifier 103 and ADC 104 may be formed as an integrated circuit on the same semiconductor die as the transducer 102, but in other arrangements the amplifier 103 and/or ADC 104 may be formed on a separate chip 105 to the transducer 102.

In use the digital microphone is coupled to an audio circuit 106, such as an audio codec. The audio codec 106 is part of a host electronic device (not illustrated) such as a mobile telephone or the like. In some instances the digital microphone 101 may also be part of the host device and thus the digital microphone may be connected to the codec via some suitable internal connective path. In some instances however the digital microphone may be part of a peripheral apparatus such as a headset or the like which may be coupled to the audio codec 106 via some suitable connector (not shown in FIG. 1) such as a jack plug and socket or a USB connector, e.g. plug and receptacle.

In use the audio codec 106 receives a data signal, DATA, indicative of the digital samples from the ADC 104. The data signal may comprise the individual samples output from the ADC or the digital microphone may comprise at least one signal processing module (not shown) downstream of the ADC 104. Typically however there may be limited signal processing in the digital microphone itself and the output from the digital microphone may typically be an oversampled PDM data stream. The audio codec 106 may provide a clock signal CLK for clocking the digital microphone 101, e.g. for clocking the ADC 104, and thus the clock signal supplied by the audio codec 106 typically determines the sample rate of the digital microphone 101. The audio codec 106 may also provide a supply or bias voltage V_{DD} to the digital microphone 101.

Typically the digital microphone 101 may be controlled to be in a powered-up or powered-down state by the supply voltage V_{DD}. The digital microphone 101 may also have a sleep mode where it is powered by the supply voltage V_{DD} but is effectively inactive.

Some digital applications may be operable at a plurality of different clock frequencies to provide a plurality of different active, i.e. non sleep, operating modes. As noted above the output (DATA) from the digital microphone 101 may be an oversampled PDM data stream. An oversampling ratio may be usually be around 64. Thus for a bandwidth of 24 kHz, comparable to a 48 kHz PCM signal, the sample rate for the PDM stream may be about 3.1 MHz. Thus the audio codec 106 may supply the clock signal CLK at around 3.1 MHz. However, generally the higher the clock frequency the more power is consumed by the microphone 101 and the downstream processing. In some applications therefore the digital microphone 101 may be operable in a plurality of different active, i.e. non-sleep, modes, for instance a high power mode with a clock frequency sufficient to provide a good quality audio representation and also a low power mode with a much reduced clock frequency. The reduced clock frequency will impact on the bandwidth and noise of the microphone output but this may be acceptable for certain functions, such as providing an always-on functionality for voice commands.

Increasingly various electronic devices are being provided with functionality to be voice controlled and it may be desirable for the device to be continually monitoring for a valid voice command, for example a mobile telephone in a device sleep mode may be monitoring for a button press or valid voice command to wake up. This requires one or more microphones associated with the device to be continually active. However running a digital microphone continuously at its nominal normal clock frequency may be wasteful of power during periods when no voice commands are issued. It is possible however to run the microphone with a reduced clock frequency so as to provide an audio signal which still has sufficient bandwidth and/or signal-to-noise ratio (SNR) to allow analysis by speech recognition algorithms to detect a voice command—or at least to detect characteristics of a voice command so that the clock frequency can be immediately stepped up to a rate sufficient to provide a higher quality audio representation of a possible voice command. In this way power saving can be made compared to running the digital microphone at the higher clock rate continuously.

In some instances the digital microphone may additionally or alternatively be operable in an ultrasonic mode to detect ultrasonic frequencies, for instance ultrasonic waves transmitted by an output transducer of the device and reflected from a nearby object, e.g. as part of a gesture recognition function. To provide an accurate representation of the incident ultrasonic stimulus the sampling rate of the digital microphone must be higher than would be required for standard audio frequencies. As mentioned however a higher clock frequency has a power cost and thus would only typically be implemented when required.

Different devices may have requirements for different modes of operation. Thus the number of active modes and the respective clock frequencies for those bands may vary from device to device or possibly even within a device for different on-board microphones intending for different functions. FIG. 2a illustrates as a representative example of two different possible requirements, A and B, for operating modes of a digital microphone. Requirement A has two active modes, a low power mode characterized by a clock frequency between F2 and F3 and a high power mode characterized by a clock frequency F4 and F5 where F5>F4>F3>F2. Requirement B has three active modes, a low power mode, an active mode and also an ultrasonic mode. However, in this instance the frequency limits F2′ to F3′ define the relatively low power mode and also the frequency limits F4′ to F5′ defining the relatively high power mode which are different to the respective power mode versus frequency limits for requirement A. In each case there may also be a sleep mode defined by a frequency range from F0 to F1 or F1′ respectively.

The various modes of operation of the digital microphone 101 may be varied by the audio codec 106 by varying the clock frequency of the clock signal CLK that is supplied to the digital microphone 101. The digital microphone 101 may use the clock frequency of the received clock signal CLK to determine a suitable mode of operation and may adjust various aspects of the digital microphone operation, such as the bias current supplied to the amplifier 103 and/or ADC 104, accordingly. As illustrated in FIG. 1 mode select circuitry 107 may be arranged to receive the input clock signal CLK and determine a mode of operation by outputting a mode signal (MODE). This mode signal (MODE) may be supplied to some controller 108 for controlling operation of the digital microphone, for instance by controlling the bias current I_{bias} supplied to the LNA 103 and/or ADC 104. For example as illustrated in FIG. 2b, if the clock frequency is above a first frequency threshold T₁ which maybe above zero hertz (0 hz) but below a second threshold T₂ then this may correspond to a low power mode of operation (thus for example T₁ and T₂ may correspond to the frequencies F2′ and F4′ in FIG. 2a). In such an instance a first bias current I₁ suitable for the low power mode may be provided. If the clock frequency is above T₂ but below a threshold T₃ (which may be set as frequency F6′ from FIG. 2a), this may correspond to a high power mode and a higher bias current I₂ may be provided. A clock frequency above T₃ (e.g. above F6′) may correspond to a further mode, say an ultrasonic mode of operation, with a corresponding third, higher, bias current I₃.

FIG. 3 illustrates one example of suitable mode select circuitry 107 for determining a mode of operation for the digital microphone 101 from the clock signal CLK. The mode select circuitry 107 has a first branch 301 for determining whether to operate in sleep mode and a second branch 302 for determining an active mode of operation.

The first circuit branch receives the clock signal CLK and an edge detect block detects a rising edge (or alternatively a falling edge) of the clock signal CLK and triggers switch 304 to be on for a short period, just long enough to discharge capacitor 305. The switch 304 then reopens and current source 306 provides a defined reference current I_{ref1} to recharge the capacitor 305. This provides a voltage V1 which ramps in a defined way and which is compared to a reference voltage V_{ref1} by comparator 307. If the voltage V1 reaches the reference voltage V_{ref1} before the end of the clock cycle (as illustrated by the waveforms at the bottom of FIG. 3) then logic 308 determines that the clock signal CLK has a low enough frequency that the digital microphone 101 should operate in sleep mode and outputs a sleep signal sleep_n with a value indicating operation in sleep mode.

If however the voltage V1 does not ramp to the reference voltage within the clock period then the clock signal CLK is high enough that the digital microphone should operate in an active mode and an appropriate value is selected for the sleep_n signal. The sleep_n signal may be provided to a control block that may for instance disable the second circuit branch 302 if sleep mode is asserted but enable the second circuit branch if the clock frequency is high enough to operate in an active mode.

It will of course be appreciated that FIG. 3 illustrates only those components useful for understanding the mode select and that in practice there may be additional components and functionality associated with operation of the microphone. For instance there may be a reset function related to the supply voltage level VDD. The mode detect circuitry may thus receive a Power-On-Reset-Not (POR_N) signal, which is used to guarantee predictable behavior of the clock detect function after power on of the digital microphone.

The second circuit branch 302 may determine which active mode to operate in. The second circuit branch has similar components as the first circuit branch and which are identified using the same reference numerals. The second circuit branch may however generate a voltage ramp using a different reference current I_{ref2} and/or compare the resulting voltage V2 to a different reference voltage V_{ref2}. If there were only two active modes of operation, say a high power mode (with a high clock frequency) and a low power mode (with a lower clock frequency), then the clock signal may effectively be tested to see if it is above or below a threshold. Thus the current reference I_{ref2} and voltage reference V_{ref2} may be arranged so that if the voltage V2 does not reach the voltage reference V_{ref2} within the relevant clock period then the high power mode is enabled, whereas if the voltage V2 does reach the reference voltage V2 the clock frequency is low enough for the low power mode.

Given that the relevant threshold frequency for the second circuit branch may be relatively high the control block may advantageously divide the received clock signal to provide a divided clock signal, clk_out, with a lower frequency. The current reference I_{ref2} and voltage reference V_{ref2} may thus be arranged to define a ramp period that corresponds to an appropriately scaled period for the desired frequency threshold. Reducing the clock frequency in this way eases the requirements on operation of the second circuit branch and conveniently the components of the second circuit branch may be very similar to those of the first circuit branch. Also using a lower frequency signal in the second circuit branch reduces power consumption.

If there is more than one threshold frequency, e.g. there are three active modes of operation, the different thresholds may be tested by the control block 309 varying the frequency division applied to the received clock signal CLK in a time division fashion to provide a divided clock signal clk_out, with one frequency threshold being tested in a first period and another frequency threshold being tested in a subsequent period.

### SUMMARY

Embodiments of the present invention relate to operating a digital microphone at different clock frequencies.

Thus according to the present invention there is provided a circuit for providing a bias current for a digital microphone comprising:
a first current generator configured to receive a clock signal supplied to the digital microphone and generate a first current based on said clock signal,
wherein the first current generator is configured to generate the first current over at least one operating band of frequencies of the clock signal such that the first current varies with the frequency of the clock signal over substantially the whole of said operating band of frequencies; and
wherein the bias current is based on said first current.

In some embodiments the first current may be supplied as said bias current.

The circuit may further comprise a sleep mode detector configured to determine when the frequency of the clock signal is lower than a first threshold frequency and assert a sleep mode signal. The circuit may be configured so as to not generate a bias current if the sleep mode signal is asserted. The sleep mode detector may, in some embodiments, comprise a comparator configured to compare a defined ramp signal with a defined reference over a cycle defined by the clock signal.

In some embodiments the first current generator may be configured such that the first current varies linearly with frequency of the clock signal over at least one operating band of frequencies. In some embodiments however other, non-linear transfer functions between the first current and frequency of the clock signal may be implemented.

In some embodiments the first current generator may be configured such that the first current varies with frequency according to a first function over a first operating band of frequencies of the clock signal and varies with frequency according to a second function over a second operating band of frequencies of the clock signal. The first function may be a linear function with a first gradient. The second function may be a linear function with a second gradient which is different to the first gradient.

In some embodiments the first current generator may be configured such that first current exhibits a step change in current if the frequency of the clock signal crosses a second threshold frequency.

The first current generator may comprise a frequency-to-current converter. In some embodiments the frequency-to-current converter may comprise: an operational amplifier with an integrating feedback capacitor; a first transistor driven by the output of the operational amplifier; a reference voltage source configured to supply a reference voltage to a first input of the operational amplifier; a current mirror configured to mirror a current flowing through the first transistor; first and second capacitors; and a switch network configured to operate in a first state in a first period of the clock signal to charge the first and second capacitors with the current output from the current mirror and to operate in a second state in a second period of the clock signal to discharge the first capacitor and connect the second capacitor between ground and a second input of the operational amplifier. In some embodiments the reference voltage source may be configurable to selectively provide one of a plurality of different reference voltages.

In some embodiments the circuit may further comprise signal processing circuitry for processing a microphone signal and outputting a digital output signal wherein the signal processing circuitry is configured to receive the bias current. The signal processing circuitry may comprise an amplifier for amplifying the microphone signal and/or an analogue to digital converter for generating the digital output signal. The circuit may further comprise a microphone transducer for producing, in use, said microphone signal, which may or may not be integrated with the signal processing circuitry. The microphone transducer may be a MEMS capacitive microphone.

Aspects also relate to electronic device comprising a circuit as described in any of the variants above. The electronic device may further comprise an audio codec, the audio codec being configured to, in use, generate the clock signal and receive the digital output signal. The audio codec may be configured to, in use, vary the frequency of said clock signal based on an operating mode of the device.

The electronic device may comprise at least one: a portable device, a battery powered device, a mobile telephone, an audio player, a video player, a computing device, a laptop, tablet or notebook computer, a games device, a wearable device and a voice activated device.

Aspects also relate to a peripheral apparatus comprising a circuit as described in any of the variants above. The peripheral apparatus may comprise a connector for connecting to an electronic device, in which case the circuit may be configured to receive the clock signal via the connector and output the digital output signal to the device via the connector.

In a further aspect there is provided a control circuit for providing a bias current for a digital microphone comprising:
a first current source configured to receive a clock signal indicative of a clock supplied to the digital microphone and generate a first current based on said clock signal;
wherein the first current source is configured such that the first current follows a defined relationship with frequency of the clock signal for at least one operating frequency band of the clock signal, wherein each value of frequency is associated with a unique value of current.

Embodiments also provide a bias circuit for generating a bias current for a digital microphone based on a clock signal supplied to the digital microphone comprising:
a frequency-to-current converter for receiving a signal based on the clock signal supplied to the digital microphone and generating the bias current such that the bias current varies continuously with the frequency of the clock signal over all of an operating band of frequencies of the clock signal.

A further aspect relates to a circuit for providing a bias current for a digital microphone, the circuit comprising a converter configured to receive a clock signal and generate the bias current based on a transfer function between the bias current and the clock signal such that each value of frequency within an active operating frequency band is associated with a unique value of current.

In a further aspect there is provided a converter for providing a bias current for a digital microphone, the converter being configured to receive a clock signal and to generate a current based on said clock signal such that said generated current has a defined transfer function with the frequency of the clock signal, wherein each value of frequency above a sleep mode frequency threshold defines a unique value of current.

A yet further aspect relates to a converter for providing a bias current for a digital microphone, the converter having a transfer function that generates a unique current based for a unique frequency of a clock signal over an active operating band of frequencies.

### BRIEF DESCRIPTION OF THE DRAWINGS

This invention will now be described by way of example only, with respect to the accompanying drawings, of which:

FIG. 1 illustrates a conventional digital microphone arrangement;

FIG. 2a illustrates examples of requirements for different operating modes of a digital microphone and FIG. 2b illustrates how bias current may be varied according to operating mode;

FIG. 3 illustrates an example of circuitry for determining the operating mode of a digital microphone from the received clock signal;

FIG. 4 illustrates a digital microphone arrangement according to an embodiment;

FIG. 5 illustrates an example of a frequency-to-current converter according to an embodiment;

FIGS. 6a and 6b illustrate examples of possible relationship between current and frequency of the clock signal;

FIG. 7 illustrates a bias current generator according to an embodiment;

FIGS. 8a and 8b illustrate the operating modes of digital microphones according to embodiments;

FIG. 9a-9d illustrate other examples of possible relationship between current and frequency of the clock signal; and

FIG. 10 illustrates how a digital microphone according to an embodiment may be used with an electronic device.

### DETAILED DESCRIPTION

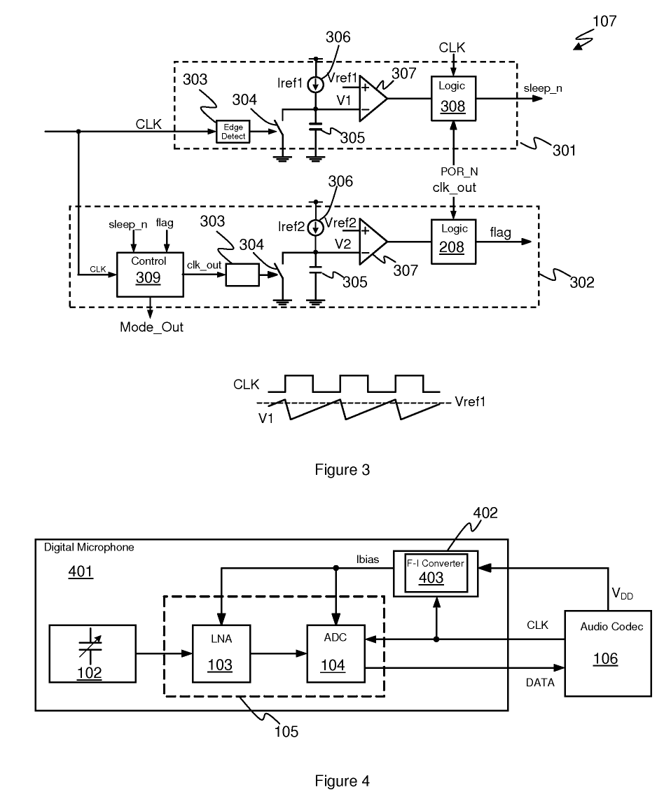

As described above a digital microphone 101 may be operable in different modes of operation at different clock frequencies CLK. The mode of operation may be controlled by changing the clock frequency CLK supplied to the digital microphone 101. To detect the relevant operating mode the digital microphone 101 may therefore have a mode detect circuit 107 as described previously with reference to FIG. 3. As noted such circuitry 107 may have a first circuit branch 301 for determining whether to operate in sleep mode or an active mode and a second circuit branch 302 to determine whether the received clock signal CLK has a frequency above or below a threshold in order to determine whether to operate in a first or a second active mode. The second circuit branch 302 can also be used to test the received clock signal CLK against other frequency thresholds by using clock division of the received clock signal CLK.

However using clock division can only easily produce integer fractions of the received clock signal. Thus if the current reference I_{ref2} and voltage reference V_{ref2} of the second branch 302, which are constant and bandgap based, are arranged to have a voltage ramp rate such that the time taken for the voltage V2 to reach V_{ref2} is equal to a time T₂, corresponding to a frequency f_{T2}=1/T₂, then by dividing the clock signal by an integer n it would effectively be possible to test frequency thresholds at integer multiples of f_{T2}. In some instances however it may be advantageous to have frequency thresholds which are non-integer multiples of each other (or a base frequency). This would therefore require an additional circuit branch for each threshold with a duplication of circuitry, adding to the cost, size and power consumption of the digital microphone 101.

As also mentioned previously, different devices, or possibly the same device, with which the digital microphone 101 may be used may also have different requirements for different active modes and frequency thresholds for entering the relevant modes, which could require a bespoke digital microphone 101 with an appropriate mode select circuit 107 for each device.

Embodiments of the present invention relate to methods and apparatus for varying the operation of a digital microphone in response to variations in the clock frequency of a clock signal supplied to the digital microphone so that the digital microphone operates satisfactorily at the supplied clock signal frequency. In particular some embodiments relate to methods and apparatus for biasing a digital microphone that at least mitigate some of the issues noted above. Embodiments may therefore relate to circuitry for providing a bias current for a digital microphone. By providing a bias current it is meant that a current is provided to at least one component of the digital microphone at a level suitable for operation of the digital microphone.

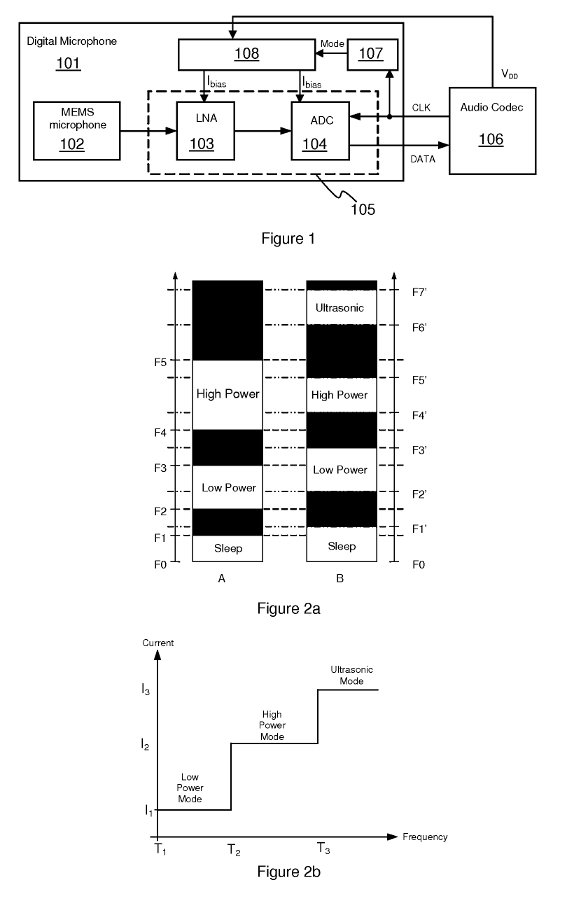

FIG. 4 illustrates a digital microphone 401 arrangement according to an embodiment of the invention in which similar components to those discussed above with respect to FIG. 1 are referred to using the same reference numerals. Digital microphone 401 comprises a transducer 102, for instance a MEMS microphone such as a MEMS capacitive microphone. The digital microphone 401 also comprises signal processing circuitry, such as an amplifier 103 and ADC 104. As discussed previously in some embodiments the amplifier 103 and possibly ADC 104 may be integrated with the transducer 102 on the same semiconductor die. In some embodiments however the amplifier 103 and/or ADC 104 may be formed on a separate chip but co-located with the transducer 102.

As also described above in use the digital microphone 401 will be coupled to audio circuitry such as an audio codec 106. The digital microphone 401 may be part of the same host device (not illustrated) as the audio codec 106 and connected by some on-board connection. In other arrangements however the digital microphone 401 may be part of an apparatus that can be removably connected to the host device, for instance part of a peripheral device such as a headset. The peripheral device may be connected via any suitable connection, whether wired or wireless, such as a jack-plug and jack-socket or USB type connection (in which case there may be some interface forming part of the connection illustrated in FIG. 4).

As described above the audio circuitry 106 may supply a clock signal CLK and a supply or bias voltage V_{DD} and receive a data signal, DATA, from the digital microphone 401. The DATA signal may, for instance, be an oversampled PDM data stream.

The frequency of the clock signal CLK may be variable by the audio circuitry 106 to control aspects of the operation of the digital microphone 401. In the embodiment of FIG. 4 the clock signal CLK is received by circuitry for providing a bias current Ibias for a digital microphone 401, i.e. a bias generator 402 which generates a suitable bias current Ibias that is appropriate for the relevant clock frequency CLK.

The bias generator 402 comprises a first current generator 403, i.e. a generator of the first current. The first current generator 403 receives the clock signal CLK and generates a first current that is based on, i.e. corresponds to, the frequency of the received the clock signal CLK. The first current generator 403 is arranged such that, for at least one operating band of frequencies of the clock signal, e.g. at least for frequencies above a first threshold, the first current varies with frequency of the clock signal over the whole or substantially the whole of the operating band of frequencies. In other words for a given operating band of frequencies of the clock signal CLK any change in the received clock signal CLK will result in a consequent change in the first current. That is any change of frequency of the clock signal from a first frequency anywhere in the operating band to a second frequency anywhere in the operating band will result in a change in first current. Thus for an instantaneous value of clock signal CLK there will be a corresponding value of current. The first current thus effectively tracks the frequency of the received clock signal according to some predetermined relationship. The relationship may be such that each possible value of the frequency of the clock signal over the operating band corresponds to a different value of the first current, that is each value of the first current corresponds to a unique frequency. In other words the valid values of the first current that can be produced have a one-to-one mapping to values of the frequency of the received clock signal. In this way the value of the first current can be used as an indication of the frequency of the received clock signal.

In some embodiments the first current may be used by the bias generator 402 to determine a relevant operating mode for the digital microphone. In at least some embodiments however the first current may be used as, i.e. supplied as, the bias current. In such embodiments the bias current thus automatically varies with received clock frequency thus meaning the effective power mode of the digital microphone automatically varies with frequency of the received clock signal. The first current generator 403 may be configured such that the first current produced at any frequency of the clock signal, at least above a first threshold, is an appropriate current for biasing one or more components of the digital microphone when operating at the frequency of the clock signal.

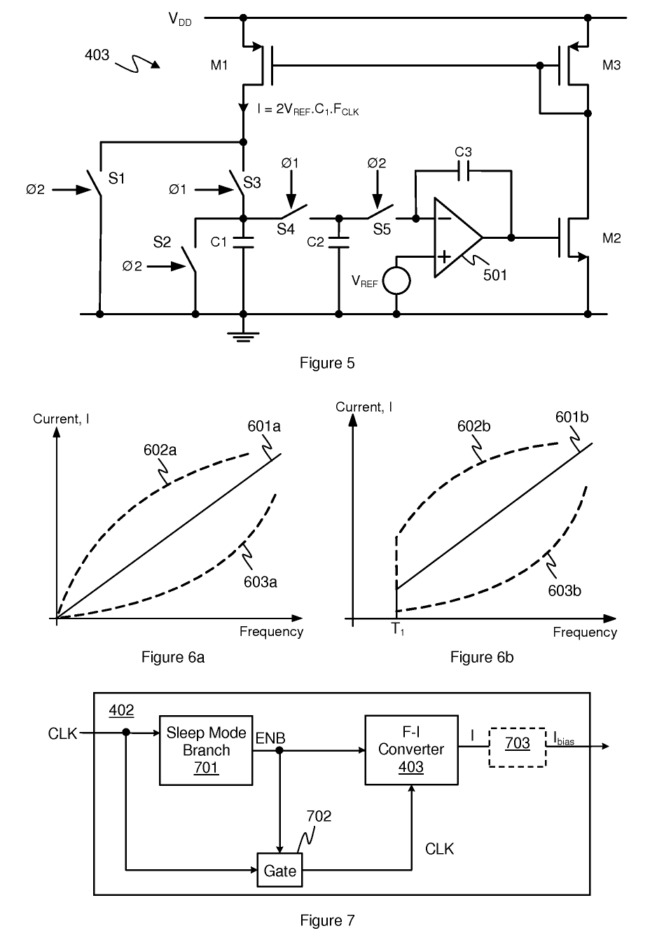

FIG. 5 illustrates one example of a suitable first current generator 403. The first current generator 403 is a frequency-to-current converter. The frequency-to-current converter 403 operates in two non-overlapping phases Φ1 and Φ2 defined by the received clock signal CLK, i.e. by the high and low phases of the clock signal. The two phases define two switch states of a switch network comprising switches S1-S5. During phase Φ2, i.e. a second switch state, switches S1, S2 and S5 are closed, with switches S3 and S4 open. With switch S2 closed and switches S3 and S4 open capacitor C1 is discharged completely. At the same time with switch S4 open and switch S5 closed the voltage of capacitor C2 is forced to be equal to the voltage reference V_{REF} by the virtual ground, i.e. the “+” terminal, of operational amplifier 501. During phase Φ1, in the first switch state, the individual states of all the switches in the switch network are reversed. The output of op amp 501 thus provides a constant voltage to the gate of transistor M2 to drive this transistor. The resulting constant current through transistor M2 is mirrored by a current mirror comprising transistors M1 and M3, thus providing a constant current to capacitors C1 and C2 when switches S3 and S4 are closed. The voltage across capacitors C1 and C2 thus ramps linearly and, at the end of phase Φ1 has a value equal to:

$$V ( C 2 ) = \frac{{C}_{2} {V}_{REF} + I Δ {T}_{1}}{{C}_{1} + {C}_{2}} \qquad Eqn . ( 1 )$$

where ΔT₁ is the duration of Φ1, C₁ is the capacitance of capacitor C1 and C₂ is the capacitance of capacitor C2.

During phase Φ2 capacitor C2 is discharged into integrating feedback capacitor C3 of the op amp 501 (whilst capacitor C1 is being discharged to ground). If the voltage across capacitor C2 is larger than the voltage reference V_{REF} the output of the op amp 501 will decrease when C2 is discharged into the virtual ground which will cause a decrease in current for the next cycle. Similarly if the voltage V(C2) of capacitor C2 is lower than V_{ref} the current will be increased for the next cycle. Thus, assuming the loop is stable, the steady state value of V(C2) is equal to V_{REF}, and the steady state current, I, will be:

$$I = \frac{{V}_{REF} {C}_{1}}{Δ {T}_{1}} = 2 {V}_{REF} {C}_{1} {F}_{CLK} \qquad Eqn . ( 2 )$$

This current could be tapped from any suitable point in the circuit.

It will be noted that the analysis above has assumed a 50% duty cycle of phases Φ1 and Φ2 for simplicity, i.e. 2ΔT₁=1/F_{CLK}. In general this will be the case for most clock signals but other forms of clock signal could be used.

Therefore, in this example the relationship, i.e. transfer function, between the first current and the input clock frequency F_{CLK} is linear and continuous. FIG. 6a illustrates how the current, I, produced by the frequency-to-current converter 402 may vary with the frequency of the clock signal according to plot 601a. It will be appreciated however that the frequency-to-current converter illustrated in FIG. 5 is only one example and other designs may be used to provide other defined relationships between frequency and current. The transfer function between the current and frequency may be linear, or some polynomial relationship may be provided, as illustrated by plots 602a and 603a in FIG. 6a.

As noted previously however it may be advantageous for the digital microphone to be operable in a non-active, e.g. sleep mode, and in such a mode no bias current may be required. In some embodiments therefore a sleep mode function may be enabled such that for clock frequencies below a threshold no bias current is produced. Whether or not the first current produced by the frequency-to-current converter is used as the bias current the bias current generator 402 may be arranged such that the frequency-to-current converter 403 does not generate a current in sleep mode so as not to waste power. As illustrated in FIG. 6b the relationship between current and clock frequency may be arranged such that there is no current produced below a first threshold T₁ that corresponds to a sleep mode threshold. Above the first threshold the current I may vary continuously, either linearly (plot 601b) or according to some polynomial (plots 602b and 603b) such that each value of clock frequency above the threshold corresponds to a unique current value.

FIG. 7 illustrates one example of a bias current generator 402 with a sleep mode functionality. The received clock signal CLK is passed to a sleep mode detector 701, which may for instance function along the same lines as the first circuit branch 301 of the mode detector circuit 107 described with reference to FIG. 3 above. The sleep mode detector 701 may thus comprise a comparator configured to compare a defined ramp signal with a defined reference over a cycle defined by the clock signal. The sleep mode detector 701 may be relatively small, crude and low power. If the sleep mode detector 701 detects that the frequency of the received clock signal CLK is below the sleep threshold T₁ then the enable signal ENB is not asserted (which is equivalent to a sleep signal being asserted) and thus the frequency-to-current converter 403 is not enabled and the clock signal CLK is blocked from being provided to the frequency-to-current converter 403 by gate 703. However if the frequency of the clock signal is above the threshold T₁ then the clock signal is passed to the frequency-to-current converter 403 which is enabled to produce a first current which varies with frequency of the clock signal. Note that as used herein the term asserting a sleep signal or an enable signal refers to generating a suitable signal so as to indicate that sleep mode operation is required or not and may refer to setting a specified value on a signal line and/or setting a flag or a value in a register or such like.

As noted above the first current I generated by the first current generator 403, i.e. the frequency-to-current converter, may be used by the bias generator to determine a mode of operation. The first current may therefore be received by a controller 703 which determines the mode of operation for the digital microphone, and hence an appropriate bias current, based on the first current.

The first current could be used to determine an operating mode by comparing the first current with a reference current using a current comparison stage. One or more reference currents could be used which are related to the desired frequency thresholds for the operating modes based on the known transfer function between clock frequency and first current. For multiple thresholds there may be multiple current comparison stages, each with an appropriate reference current and/or at least one current comparison stage may be operable with a variable reference current, i.e. the reference current could be trimmed to provide an appropriate comparison value. Alternatively the first current could be used to bias a selected resistance to generate a voltage based on the first current that can be compared to a reference voltage, which could for instance be bandgap based, and which is set based on the known transfer function between clock frequency and first current and also the value of the resistance. Again the reference voltage and/or resistance to which the first current is applied may be varied to provide different thresholds.

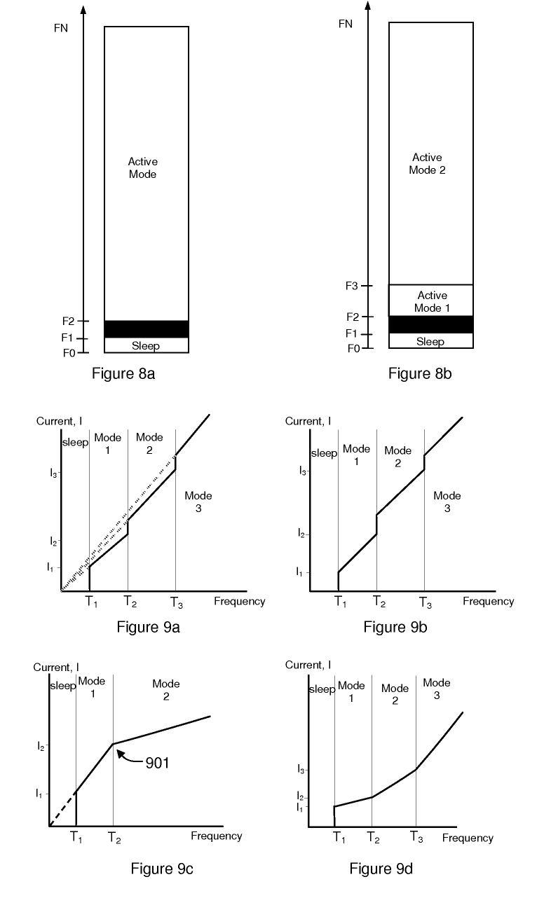

Advantageously however the first current generated by the frequency-to-current converter may be used as the bias current I_{bias} without the need for a controller 703. Such a digital microphone could be seen as having a single active mode but where the clock frequency and bias current is variable within the mode. Thus the operating range over which the first current varies with the frequency of the clock signal may be the whole frequency range above a sleep mode threshold up to a maximum operating frequency threshold, i.e. a maximum operating clock frequency that the digital microphone 401 can operate at. FIG. 8a illustrates this principle. Above a threshold frequency, say F2, which may be of the order of 50 kHz or so, the frequency-to-voltage converter 403 is active and supplying a bias current which is appropriate for and which varies with the clock frequency. The digital microphone thus can be operable in an active mode at any clock frequency and a device manufacturer can position as many different bands of operation as are needed up to some maximum clock frequency FN. For a clock signal frequency below the frequency threshold F2 the digital microphone may be in sleep mode, although in practice the audio codec may avoid using a clock frequency below F2 which is relatively close to F2, thus the audio codec may be configured not to use a frequency band between F1 and F2.

Outputting the first current as the bias current may thus avoid the need for detecting an operating mode as such and instead the bias current varies with frequency over the entire operating range of the digital microphone, above any sleep mode threshold frequency, in accordance with a defined transfer function so that bias current adapts automatically to an appropriate level based on the frequency of the received clock signal. In some embodiments however at least some functionality of the microphone may vary with the frequency of the clock signal, i.e. there may be some capabilities that are turned on or off at different threshold frequencies. In this case there will still be different modes of operation of the microphone, as illustrated by FIG. 8b where above a clock frequency F2 the microphone is active but certain functionality is enabled or disabled above or below a clock frequency F3 to provide two different active modes—but both with a varying bias current. The first active mode could for instance provide always-on voice command functionality as discussed above where some functionality of the microphone may not be required and is thus disabled or unpowered, with the second active mode providing full functionality. The mode of operation may be determined based on the bias current, for instance by current or voltage comparison as discussed above. Additionally or alternatively the bias current may be supplied to various components of the digital microphone that may only operate if the bias current is above a certain level.

It will be noted that where the first current is used as the bias current this means that any change of frequency of the received clock signal CLK will result in a consequent change in bias current. This is in contrast to the conventional approach illustrated in FIG. 2b where a change of frequency of the clock signal that does not cross one of the defined thresholds would not result in a change in frequency.

Referring back to FIGS. 6a and 6b in these examples the current generated by the frequency-to-current generator is continuous and smooth with frequency, at least above the threshold frequency for sleep mode. In some embodiments the transfer function between current and frequency could itself vary over the frequency range. For example it will be seen from equation 2 above that the current generated by the frequency-to-current converter 403 illustrated in FIG. 5 is proportional to the voltage reference V_{REF}. Changing V_{REF} would thus change the gradient of current increase with frequency of the clock signal. In some embodiments the value of V_{REF} may be varied over part of the operating range of the digital microphone so that the current produced by the frequency-to-current converter varies with the frequency of the clock signal in a suitable way to provide the bias current for the digital microphone.

For example FIG. 9a illustrates that for clock frequencies below a first threshold the digital microphone may exhibit a sleep mode with no bias current. For a frequency of clock signal above the threshold T₁ but below a threshold T₂ the current I may rise, form a value I₁ to a value I₂ with a given gradient. At a certain frequency threshold T₂ (or equivalently current I₂) the value of V_{REF} may be altered to change the rate of change of current with frequency. As from equation 2 the value of current is proportional to V_{REF} a sudden jump in V_{REF} will also result in a jump in the output current—thus the relationship of current with frequency will exhibit a step change at the transition point, e.g. threshold T₂. FIG. 9a illustrates that there may be an additional increase in V_{REF} at another frequency threshold T₃ (or current I₃), resulting in another step change in current and an increased rate of change of current with frequency thereafter. The voltage reference could be changed when the first current crosses reference current thresholds or reference voltage thresholds as discussed above, with an appropriate threshold being set based on the present value of V_{REF}.

In other words the first current can be seen to vary with frequency according to a first function over a first operating band of frequencies of the clock signal, e.g. between T₁ and T₂, and vary with frequency according to a second function (different to the first function) over a second operating band of frequencies of the clock signal, e.g. T₂ to T₃.

In some respects the operating range between T₁ and T₂ may be seen as a first active operating mode, which may for instance correspond to a low power mode, with the operating range between T₂ and T₃ being a second active operation mode, e.g. possibly corresponding to a high power mode and the operating range above T₃ being a third active mode which may for instance correspond to an ultrasonic mode of operation. The relationship between the first current and the clock frequency may be configured to have any form required to provide a sufficient bias current at the intended frequency of operation by appropriate design of the first current generator, i.e. the frequency-to-current converter. The relationship between current and frequency could be continuous, continuous piecewise linear, non-continuous piecewise linear, i.e. with steps between different active modes, polynomial or any other relationship. As noted above however the relationship may be such that there is a one-to-one mapping between a value of current and a frequency of the clock signal CLK over the active operating band(s), i.e. clock frequency range, of the digital microphone. In other words the relationship over the active range identifies a unique value of current for each different value of the frequency.

FIGS. 9b to 9d illustrate various examples of possible relationships. FIG. 9b illustrates a characteristic where the gradient of current with frequency is the same in each operating mode but there is a step change in current as the frequency of the clock signal crosses a particular frequency threshold. This could be achieved for instance by selectively adding currents from one or more current references to the current generated by the frequency-to-current converter. FIGS. 9c and 9d illustrate embodiments where the gradient of change of current with frequency may decrease (FIG. 9c) or increase (FIG. 9c) as frequency thresholds are crossed.

The embodiments discussed above thus relate to a digital microphone 401 where operation of the microphone in an active mode of operation is primarily controlled through signaling by varying the frequency of the clock signal CLK received by the digital microphone 401. For many types of digital microphone size is important and the microphone package may have a limited pin count. A supply pin may be used to receive the supply voltage VDD may be used to signal powered up or powered down operation or a reset. A clock pin is used for providing the clock signal CLK to the digital microphone and a data out pin is used for outputting data from the microphone. There may also be a L/R select indicating whether data should be aligned with the left or right edge of clock pulse, allowing two microphones to use the same clock and data lines.

In some embodiments however there may be additional communication functionality between the digital microphone 401 and associated audio circuitry 106. For instance in some embodiments there may be additional means by which the audio codec could signal information about operation in an active mode to the digital microphone.

As noted previously changing the clock frequency does provide power savings but at the expense of bandwidth of the data. In some instances it may be desirable to provide the ability to have different active modes of operation that have different power consumption and/or provide some different functionality but at the same general clock frequency. For example it may be desired to have a relatively low power ultrasonic mode, for example as part of some ultrasonic wake-up functionality or simple proximity sensing mode rather than full gestured recognition. In which case much of the functionality of the digital microphone could be disabled but a relatively high clock frequency is required. Using the clock frequency alone it may not therefore be possible to distinguish from say a high power, high quality audio mode. However if another communication channel is available then the combination of the clock signal and some other control signal could provide a greater functionality in control over operating mode. The communication could be could be via an existing pin, for instance in some embodiments the supply voltage may be set at two different valid active levels. In some embodiments however there may be a dedicated control pin for receiving control information from the codec 106.

Whilst having a dedicated control pin for the receipt of control information would allow a information regarding a desired mode of operation to be communicated directly from the codec it is still advantageous to have the digital microphone to adapt automatically to changes in clock frequency for power efficiency and/or to simply the on-chip control circuitry of the digital microphone. In some embodiments where such a control terminal is available the codec 106 may be configured to program the bias generator, and in particular the first current source, to control the transfer function between clock frequency and bias current according to the desired use case. In some embodiments a control pin on the digital microphone 401 may allow for two way communication with the codec 106.

Embodiments of the invention therefore relate to biasing circuitry for biasing a digital microphone that is operable at a plurality of different clock frequencies. The biasing circuitry may be formed as part of the digital microphone and arranged to supply a bias current to at least one of an amplifier and/or an ADC of the digital microphone. The biasing circuitry may be integrated with the amplifier and/or an ADC of the digital microphone.

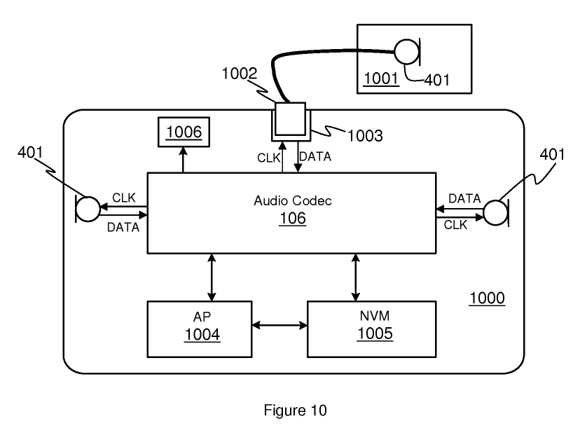

The digital microphone in use will be connected to suitable audio circuitry such as an audio codec of a host device. Such a digital microphone may be implemented in an electronic apparatus or host device 1000 as illustrated in FIG. 10, especially a portable and/or battery powered host device such as a mobile telephone, an audio player, a video player, a PDA, a mobile computing platform such as a laptop computer or tablet and/or a games device for example. This host device comprises an audio codec 106 which may be connected to one or more on-board digital microphones 401 according to embodiments of the invention. Additionally or alternatively the digital microphone 401 may form part of a peripheral apparatus 1001 which may be connected to the host device 1000 in use, for instance via a plug 1002 of the peripheral apparatus and receptacle 1003 of the host device.

The audio codec may vary the clock signal CLK supplied to the digital microphone(s) to vary the operation of the digital microphone, for example to operate in a high quality mode for voice communications or video or audio recording, to operate in an ultrasonic mode for gesture recognition or the like and in a low power mode to provide an always-on functionality for voice commands. The mode of operation may in some instance be specified by an applications processor 1004. Details about the respective clock frequencies for each operating mode may be received from the applications processor 1004 and/or some memory 1005 such as non-volatile memory. Data received from the digital microphone(s) in use may be communicated to the applications processor 1004 and/or stored in a memory 1005 and/or relayed to a communication module 1006, e.g. for wireless transmission.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope. Terms such as amplify or gain include possibly applying a scaling factor of less than unity to a signal.

1. A circuit for providing a bias current for a digital microphone comprising:
a first current generator configured to receive a clock signal supplied to the digital microphone and generate a first current based on said clock signal,
wherein the first current generator is configured to generate the first current over at least one operating band of frequencies of the clock signal such that the first current varies with the frequency of the clock signal over substantially the whole of said operating band of frequencies; and
wherein the bias current is based on said first current.

2. A circuit as claimed in claim 1 wherein the first current is supplied as said bias current.

3. A circuit as claimed in claim 1 comprising a sleep mode detector configured to determine when the frequency of the clock signal is lower than a first threshold frequency and assert a sleep mode signal.

4. A circuit as claimed in claim 3 wherein the circuit is configured to not generate a bias current if the sleep mode signal is asserted.

5. A circuit as claimed in claim 3 wherein the sleep mode detector comprises a comparator configured to compare a defined ramp signal with a defined reference over a cycle defined by the clock signal.

6. A circuit as claimed as claimed in claim 1 wherein the first current varies linearly with frequency of the clock signal over at least one operating band of frequencies.

7. A circuit as claimed as claimed in claim 1 wherein the first current varies with frequency according to a first function over a first operating band of frequencies of the clock signal and varies with frequency according to a second function over a second operating band of frequencies of the clock signal.

8. A circuit as claimed in claim 7 wherein said first function is a linear function with a first gradient and said second function is a linear function with a second gradient which is different to the first gradient.

9. A circuit as claimed as claimed in claim 1 wherein the circuit is configured such that first current exhibits a step change in current if the frequency of the clock signal crosses a second threshold frequency.

10. A circuit as claimed in claim 1 wherein the first current generator comprises a frequency-to-current converter.

11. A circuit as claimed in claim 10 wherein the frequency-to-current converter comprises:
an operational amplifier with an integrating feedback capacitor;
a first transistor driven by the output of the operational amplifier;
a reference voltage source configured to supply a reference voltage to a first input of the operational amplifier;
a current mirror configured to mirror a current flowing through the first transistor;
first and second capacitors; and
a switch network configured to operate in a first state in a first period of the clock signal to charge the first and second capacitors with the current output from the current mirror and to operate in a second state in a second period of the clock signal to discharge the first capacitor and connect the second capacitor between ground and a second input of the operational amplifier.

12. A circuit as claimed in claim 11 wherein the reference voltage source is configurable to selectively provide one of a plurality of different reference voltages.

13. A circuit as claimed in claim 1 further comprising signal processing circuitry for processing a microphone signal and outputting a digital output signal wherein the signal processing circuitry is configured to receive the bias current.

14. A circuit as claimed in claim 13 wherein said signal processing circuitry comprises at least one of an amplifier for amplifying the microphone signal and an analogue to digital converter for generating the digital output signal.

15. A circuit as claimed in claim 13 further comprising a microphone transducer for producing, in use, said microphone signal wherein said microphone transducer is a MEMS capacitive microphone.

16. An electronic device comprising a circuit as claimed in claim 13 and further comprising an audio codec, said audio codec being configured to, in use, generate said clock signal and receive said digital output signal wherein said audio codec is configured to, in use, vary the frequency of said clock signal based on an operating mode of the device.

17. An electronic device as claimed in claim 16 wherein the electronic device comprises at least one: a portable device, a battery powered device, a mobile telephone, an audio player, a video player, a computing device, a laptop, tablet or notebook computer, a games device, a wearable device and a voice activated device.

18. A peripheral apparatus comprising a circuit as claimed in claim 13 and a connector for connecting to an electronic device, the circuit being configured to receive said clock signal via said connector and output the digital output signal to said device via said connector.

19. A bias circuit for generating a bias current for a digital microphone based on a clock signal supplied to the digital microphone comprising:
a frequency-to-current converter for receiving a signal based on the clock signal supplied to the digital microphone and generating the bias current such that the bias current varies continuously with the frequency of the clock signal over all of an operating band of frequencies of the clock signal.

20. A circuit for providing a bias current for a digital microphone, the circuit comprising a converter configured to receive a clock signal and generate the bias current based on a transfer function between the bias current and the clock signal such that each value of frequency within an active operating frequency band is associated with a unique value of current.
